(19) United States
(12) Patent Application Publication
(10) Pub. No.: US 2014/0122103 A1
(43) Pub. Date: May 1, 2014

(54) DIAGNOSTIC REPORT GENERATION SUPPORT APPARATUS

(71) Applicants: Toshiba Medical Systems Corporation, Otawara-shi (JP); Kabushiki Kaisha Toshiba, Tokyo (JP)

(72) Inventors: Akihiko Yoshida, Ota-ku (JP); Maki Minakuchi, Utsunomiya-shi (JP)

(73) Assignees: Toshiba Medical Systems Corporation, Otawara-shi (JP); Kabushiki Kaisha Toshiba, Tokyo (JP)

(21) Appl. No.: 13/882,007

(22) PCT Filed: Mar. 5, 2013
(86) PCT No.: PCT/JP13/56001

§ 371 Date: Apr. 26, 2013

(30) Foreign Application Priority Data
Mar. 5, 2012 (JP) 2012 047795

(51) Int. Cl. G06F 19/00

(52) U.S. Cl. CPC G06F 19/321; G06F 19/345
USPC 705/2

(57) ABSTRACT

To provide a diagnostic report generation support apparatus that can shorten the time required for selecting a form. The diagnostic report generation support apparatus according to the embodiment comprises a first controller, an extraction unit, and a second controller. The first controller stores one or more pieces of the specific information to be referred to when the form is used in relation to the form types used in the past in a first storage in advance. The extraction unit extracts the specific information to be referred to common to respective forms from among the specific information stored in the first storage in advance for each form type and generates a common combination. The second controller stores a common combination of the specific information in a second storage in advance for each form type.

### FIELD OF THE INVENTION

The embodiment of the present invention pertains to a diagnostic report generation support apparatus.

### BACKGROUND OF THE INVENTION

Regarding medical images, the medical images of a patient are photographed, for example, by a medical imaging apparatus such as an X-ray computed tomography system (CT) or a magnetic resonance imaging apparatus (MRI). The photographed medical images are archived in a medical image archive apparatus.

The medical image archive apparatus and a diagnostic report generation support apparatus are connected to the medical imaging apparatus via a network.

The medical image archive apparatus archives the photographed medical images. A radiologist acquires medical images from the medical image archive apparatus using the diagnostic report generation support apparatus, and inputs findings with respect to medical images in the findings section of a report. Further, a diagnostic report is sometimes referred to as a written report or a merely a report.

A form input function exists as an example of a function supporting the generation of a report. The form input function registers forms that are frequently input in the findings section in advance. Then, if the registered form is selected by the radiologist, this function is used to paste the selected form to the findings section.

The radiologist generates findings with reference to information upon examination and information upon operating images (information upon examination, etc.). The texts generated as findings are classified based on the type of text (referred to as the “form type”) depending on which information is referred.

Accordingly, the radiologist selects a form with reference to information upon examination, etc. in the case of selecting a form type, then generates findings based on the form.

### PRIOR ART DOCUMENTS

### Patent Documents

[Patent document No. 1] Japanese published unexamined application No. 2011-186828

### SUMMARY OF THE INVENTION

### Problem to be Solved by the Invention

However, there is a problem of excessive time when selecting form sentences corresponding to the present findings from among a plurality of selected form candidates.

The present embodiment aims to solve the above-described problem, with the object of providing a diagnostic report generation support apparatus that automatically extracts a form candidate and shortens the time required for selecting a form.

### Means of Solving the Problems

In order to solve the above-described problem, the diagnostic report generation support apparatus according to the embodiment comprises a first controller, an extraction unit, and a second controller. The first controller stores one or more pieces of the specific information to be referred to when the form is used in relation to the form types used in the past in a first storage in advance. The extraction unit extracts the specific information to be referred to that is common to respective forms from among the specific information stored in the first storage in advance for each form type and generates a common combination. The second controller stores a common combination of the specific information in a second storage in advance for each form type.

### BRIEF DESCRIPTION OF THE DRAWINGS

FIG. 1 is a functional block diagram of the configuration of an image diagnosis department system including the diagnostic report generation support apparatus according to the first embodiment.

FIG. 2 is a conceptual illustration of bibliographic information/image operation information stored in the first storage.

FIG. 3 is a conceptual illustration of bibliographic information/image operation information stored in the first storage, and a common combination of the specific information extracted therefrom.

FIG. 4 is a conceptual illustration of a selected form type.

FIG. 5 is a flow chart depicting when a combination of the specific information is stored in advance upon generation of a diagnostic report.

FIG. 6 is a flow chart depicting when the specific information combined in common is extracted.

FIG. 7 is a flow chart depicting when a form is used upon the generation of a diagnostic report.

FIG. 8 is a conceptual illustration of the input specific information according to the second embodiment and the form types extracted based on the information.

FIG. 9 is a flow chart depicting when a form is used upon the generation of a diagnostic report.

### DETAILED DESCRIPTION OF THE INVENTION

### First Embodiment

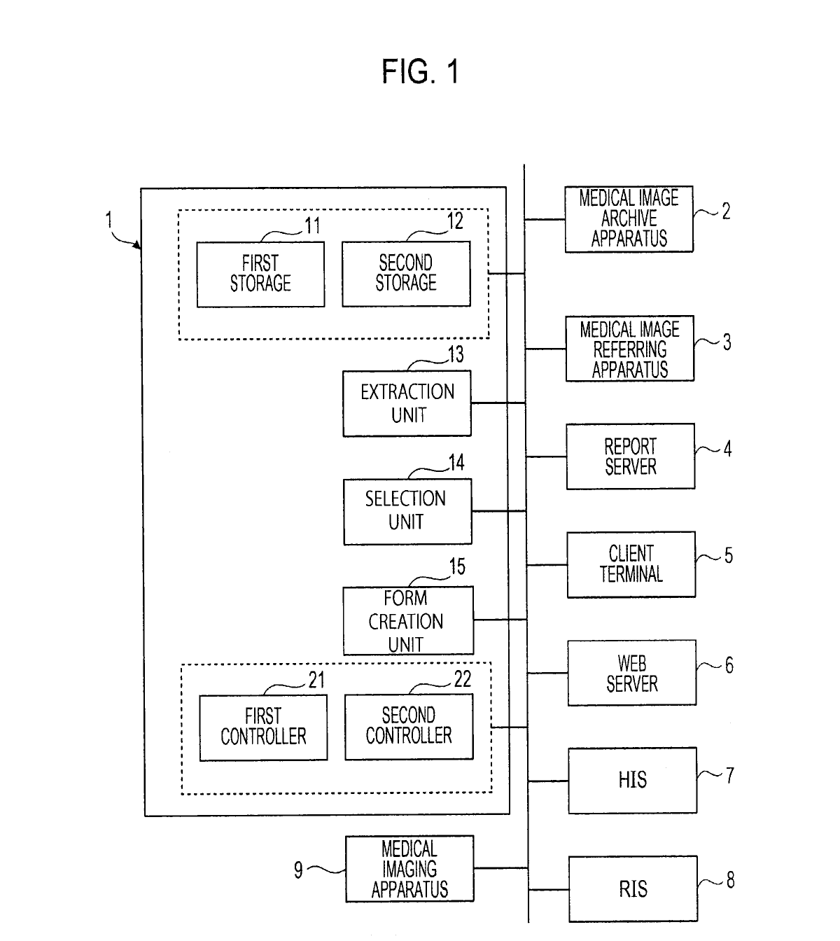

The first embodiment of this diagnostic report generation support apparatus will be described with reference to FIG. 1. FIG. 1 is a functional block diagram of the configuration of an image diagnosis department system including a diagnostic report generation support apparatus.

In the image diagnosis department system, a diagnostic report generation support apparatus 1, a medical image archive apparatus 2, a medical image referring apparatus 3, a report server 4, a client terminal 5, a web server 6, a hospital information system (HIS; Hospital Information System) 7, a radiology information system (RIS; Radiology Information System) 8, and a medical imaging apparatus (modality) 9 are connected to each other via a network. Here, the diagnostic report generation support apparatus may include the diagnostic report generation support apparatus 1 with a combination of one or more of the above-described apparatuses or systems other than the diagnostic report generation support apparatus 1, or may be configured by the single diagnostic report generation support apparatus 1.

A doctor in the diagnosis department issues an examination order (examination order) at a terminal of the HIS 7 while considering the condition of the patient. The examination order is computerized and transmitted to the RIS 8 via a network. A cameraman confirms the examination order from a terminal of the RIS 8, and photographs the patient with the medical imaging apparatus 9. Thereby, medical images are generated. The generated medical images are transferred to the medical image archive apparatus 2 by means of DICOM (Digital Imaging and Communication in Medicine) that is the standard communication specifications for medical information, after which they are archived and managed.

The radiologist interprets a radiogram (the operation for screening the findings imaged on the medical images) while observing the transferred medical images using the medical image referring apparatus 3, and generates a diagnostic report (a written report) summarizing the results of the interpretation of the radiogram. Upon interpretation of the radiogram, the radiologist interprets the radiogram centering on the object of the examination indicated by the doctor in the diagnosis department, and describes responses related to the purpose of the examination; however, this describes all lesions imaged on the medical images in addition to the content related to the purpose of the examination. Accordingly, parts other than the responses related to the examination purpose are described in the findings of the diagnostic report. The generated diagnostic report and medical images are archived in the web server 6 that configures the hospital image reference system.

The radiologist can shorten the time for generating a report by using the diagnostic report generation support apparatus 1. The details of the diagnostic report generation support apparatus 1 will be described later.

Users including the doctor in the diagnosis department can simply refer to the archived medical images and diagnostic reports by accessing the web server 6 using a web browser from a terminal of the HIS 7 arranged in the hospital or the client terminal 5.

Next, the configuration of the diagnostic report generation support apparatus 1 will be described with reference to FIG. 1.

The configuration of the diagnostic report generation support apparatus 1 includes a first storage 11, a second storage 12, an extraction unit 13, a selection unit 14, a form creation unit 15, a first controller 21, and a second controller 22.

The diagnostic report generation support apparatus 1 has a function to extract a common combination of the specific information referred to when the form is used upon generation of a report and store the combination in advance (a form pattern extracting function), and a function to receive the combination of the specific information upon the following generation of a report, select the form type to be used, and paste the form to the report (an automatic form creating function).

Using the specific information to be referred to upon generation of a report as a key word, this diagnostic report generation support apparatus 1 stores the common combination of these in advance, automatically extracts a form candidate with reference to the common combination of these upon the following generation of a report, and accordingly, shortens the time for generating a report by shortening the time required for selecting the form.

A form pattern extracting function is configured by the first storage 11, the second storage 12, the extraction unit 13, the first controller 21, and the second controller 22. In addition, a form automatic creating function is configured by the second storage 12, the selection unit 14, and the form creation unit 15.

The information obtained upon examination and upon operating images is classified into bibliographic information (bibliographic information) according to the examination, and information (image operation information) for editing the images obtained by the examination in order to interpret the images and indicate the image operation. For example, the bibliographic information is input into a text box of an input screen of the diagnostic report generation support apparatus 1 as a character string. In addition, for example, the image operation information is input into an input screen of the medical image referring apparatus 3 as a character string. In the following description, respective bibliographic information/image operation information is sometimes referred to as specific information. In addition, the specific information to be input in respective input screens may be simply referred to as “input information.”

The radiologist refers to a combination of the specific information (bibliographic information/image operation information) in the case of selecting the form type. Therefore, it is preferable that the combination of the specific information and the form have an adapted correspondence relation.

Therefore, the specific information referred to when a form was created in the past is extracted while classifying it into bibliographic information and image operation information. The specific information is stored in the first storage 11 as a character string.

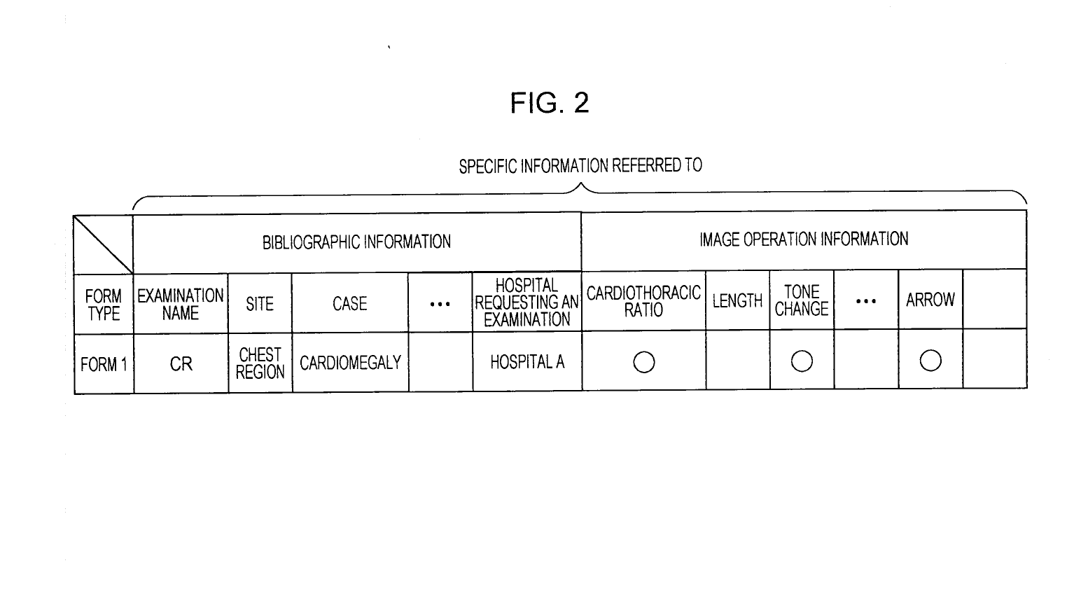

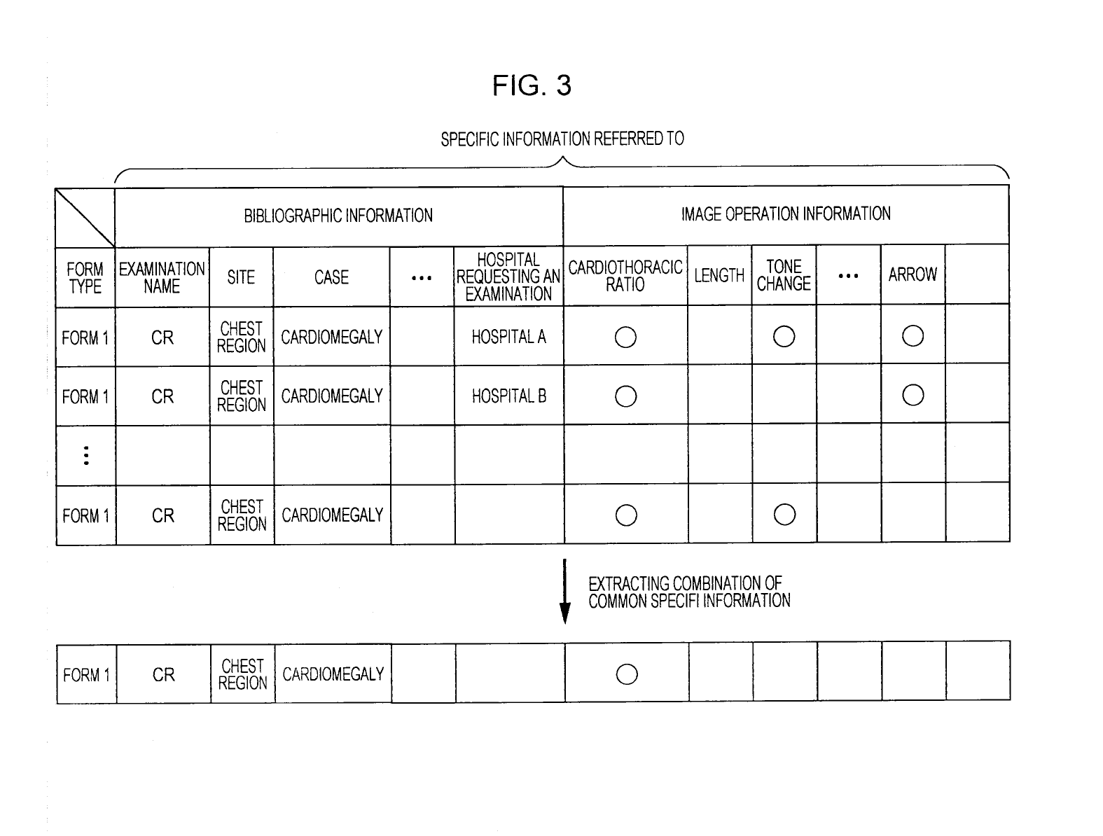

The bibliographic information and the image operation information classified and extracted are illustrated in FIG. 2. In addition, the specific information combined for each form type is illustrated in the top part of FIG. 3.

The bibliographic information includes the information (information obtained from the examination order, manually-input information, and form information input in the past) input into the report.

The manually-input information includes information related to the imaging of medical images such as examination names, examination sites, clinical disease names, medical histories, drugs, and a hospital that introduces a patient, or request fees, or a combination of two or more of these.

Further, the bibliographic information may include at least an examination name. Here, as an examination name, a means for imaging medical images such as CR (computed radiography: computed radiography), MRI (magnetic resonance imaging: magnetic resonance imaging), and CT (computed tomography: computed tomography) is included.

In addition, the image operation information includes operation history information in the medical image referring apparatus 3. The operation history information includes tone change, image processing, the cardiothoracic ratio, or information related to technology for generating medical images such as measurement marking or a combination of two or more of these. As image operation information, at least tone change may be included. Here, the cardiothoracic ratio is the ratio of the width of the heart to the width of the chest (chest region).

Accordingly, an example of a combination of specific information includes a combination of examination names and one or more pieces of other bibliographic information, a combination of tone change and one or more pieces of other image operation information, and further, a combination of at least examination names and tone change.

### [Form Pattern Extracting Function]

Next, a means of configuring a form pattern extracting function will be described in the order of the first controller 21, the extraction unit 13, and the second controller 22.

### (First Controller)

FIG. 2 is a conceptual illustration of bibliographic information/image operation information stored in the first storage 11.

FIG. 2 illustrates the bibliographic information/image operation information stored in relation to the form type as a data structure of an array type. In addition, the first column indicates the form type, while the first row indicates the type of specific information. Further, the second column to the kth column indicate respective item names (“examination name,” “site,” “case,”, “hospital requesting an examination”), in addition to indicating the bibliographic information (“CR,” “chest region,” “cardiomegaly,” . . . , “hospital A”) stored in relation to these items.

Further, the k+1th column to the nth column indicate the names of respective items (“cardiothoracic ratio,” “length,” “tone change,” “arrow”), in addition to indicating the image operation information (“◯,” “,” “◯,” . . . , “◯”) stored in relation to these items. Here, “◯” indicates that the item corresponding to the column has been input. In addition, “ ” (blank) indicates that the item corresponding to the column has not been input.

In the first storage 11, a bibliographic information list is stored along with image operation information. The first controller 21 receives the input information, refers to the bibliographic information list and image operation information, and extracts the bibliographic information/image operation information. The assembly of extracted bibliographic information/image operation information becomes a combination of specific information.

The first controller 21 stores a combination of specific information in relation to the form types used in the past in the first storage 11. Here, “the past” means the time period before the present form started being used.

In the example indicated in FIG. 2, the form type is “form 1.” In addition, the combination of the specific information is “CR,” “chest region,” “cardiomegaly,” . . . , “hospital A,” “◯,” “,” “◯,” . . . , “◯”.

### (Extraction Unit)

FIG. 3 conceptually illustrates the bibliographic information/image operation information stored in the first storage, along with the common combination of the specific information extracted therefrom. The top part of FIG. 3 illustrates the specific information (bibliographic information/image operation information) referred to when the form was used in the past. Further, the top part of FIG. 3 indicates the specific information stored related to “form 1” in order to simplify the explanation, while the illustration of the specific information stored in relation to other form types (“form 2,” “form 3,” . . . “form m”) is omitted.

The bottom part of FIG. 3 illustrates the common specific information among three pieces of “form 1,” and other specific information. The common combination of specific information is indicated by “CR,” “chest region,” “cardiomegaly,” and “◯” in the cardiothoracic ratio.

The extraction unit 13 extracts specific information common to respective forms from among the specific information stored in the first storage 11 in advance for each form type and generates a common combination. In the present embodiment, “common” is represented as “perfect matching.” In addition, not limited to this, “common” may be represented as “similar.” At this time, a list of similar terms (for example, character strings) is registered, and the extraction unit 13 may determine whether or not the specific information is similar with reference to this list.

As illustrated in the bottom part of FIG. 3, the extraction unit 13 extracts a common combination of specific information (“CR,” “chest region,” “cardiomegaly,” and “◯” of the cardiothoracic ratio) with respect to “form 1.” Extraction by the extraction unit 13 is omitted with respect to the forms on and after form 2.

### (Second Controller)

The second controller 22 stores a common combination of specific information in the second storage 12 in advance for each form type. As an example indicated in the bottom part of FIG. 3, a common combination of specific information (“CR,” “chest region,” “cardiomegaly,” and “◯” in the cardiothoracic ratio) is stored with respect to “form 1.”

Thus, when a form is created with a form pattern extracting function configured by the first controller 21, the extraction unit 13, and the second controller 22, upon generation of a report, the specific information to be always referred to is stored in the second storage 12 as common specific information. In other words, an adapted correspondence relation between a common combination of the specific information and the form type is maintained. As a result, if the common combination of specific information is referred to, an appropriate form candidate can be automatically extracted, making it possible to shorten the time required for selecting a form.

### [Form Automatic Creating Function]

Next, a form automatic creating function configured by the second storage 12, the selection unit 14, and a form creation unit 15 will be described. Hereinafter, the description will be given in the order of the selection unit 14 and form creation unit 15.

### (Selection Unit)

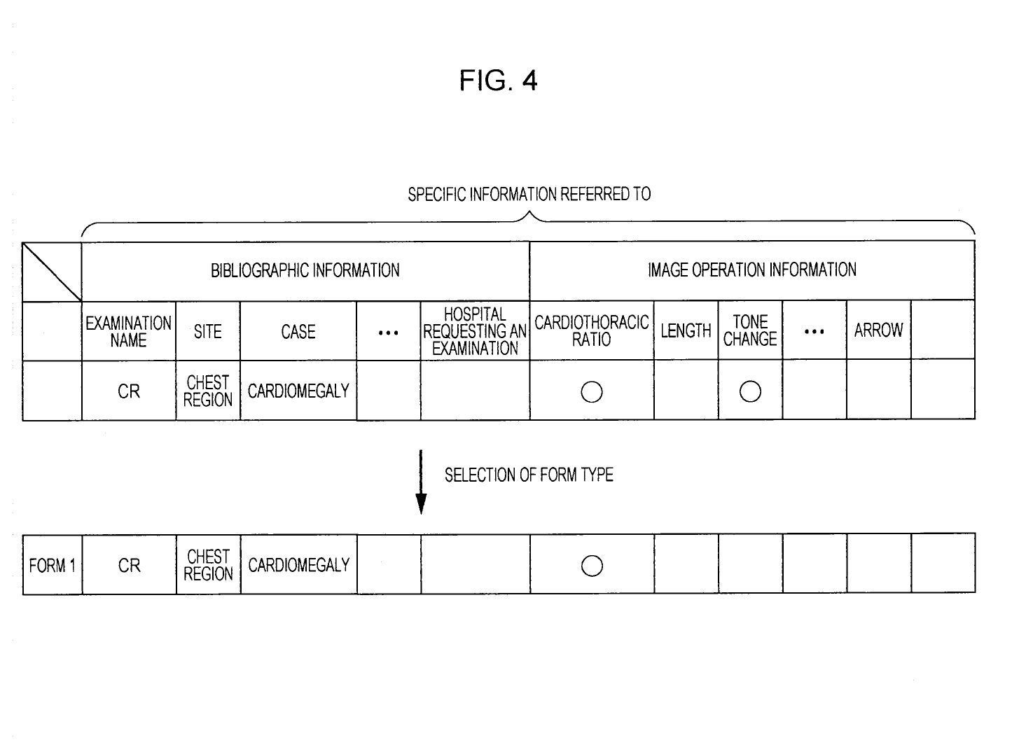

Next, the selection unit 14 will be described with reference to FIG. 4. FIG. 4 is a conceptual illustration of a selected form type.

The specific information is input into the selection unit 14 upon generation of a report. The top part of FIG. 4 indicates the input and temporarily stored specific information (“CR,” “chest region,” “cardiomegaly,” cardiothoracic ratio “◯,” tone change “◯”).

The selection unit 14 compares the combination of the input specific information (indicated in the top part of FIG. 4) to the common combination of the specific information stored in advance in the second storage 12. The bottom part of FIG. 3 indicates one of the common combinations of specific information (“CR,” “chest region,” “cardiomegaly,” cardiothoracic ratio “◯”).

Further, the selection unit 14 derives the combination of the highest amount of specific information matching between both sides. The derived combination of the highest amount of specific information includes “CR,” “chest region,” “cardiomegaly,” and the cardiothoracic ratio “◯.” Further, the selection unit 14 automatically selects a form type based on the combination of the maximum specific information. The bottom part of FIG. 4 indicates the automatically selected form type, namely, “form 1,” and the specific information related to this.

### (Form Creation Unit)

The form creation unit 15 pastes the selected form type to the report.

Thus, the form automatic creating function configured by the selection unit 14 and the form creation unit 15 automatically extracts form candidates based on the input specific information, and selects a form type from these. This makes it possible to avoid troublesome procedures for manually selecting a form type and shorten the time required for generating a report.

### [Operation]

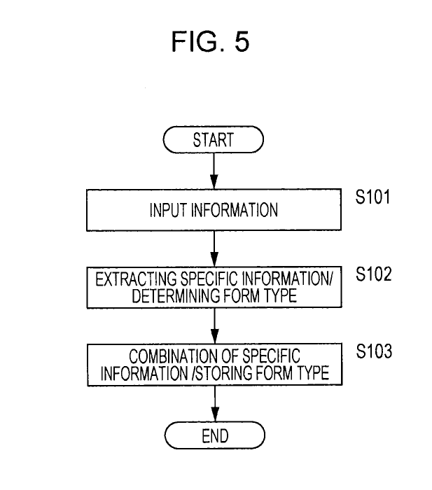

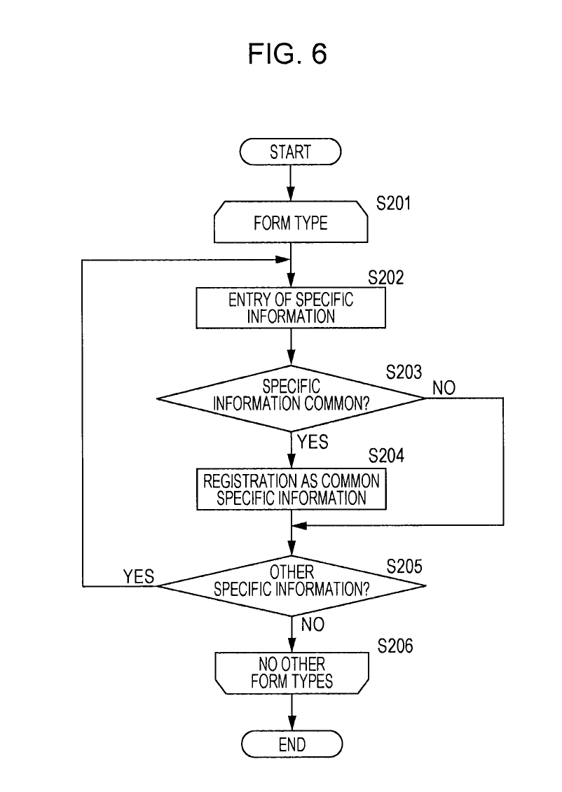

Next, a form pattern will be described with respect to the sequence of operations of the extracting function with reference to FIG. 5 and FIG. 6.

First, the sequence of operations until the form type and the combination of input specific information are stored will be described with reference to FIG. 3 and FIG. 5. FIG. 5 is a flow chart depicting when a combination of specific information is stored in advance upon generation of a diagnostic report.

### (S101)

As illustrated in FIG. 5, the first controller 21 receives the input information, and temporarily stores it, for example, in an inner memory.

### (S102)

The first controller 21 refers to, for example, a bibliographic information list stored in the first storage 11, and extracts specific information from the information input into an input screen. The first controller 21 extracts the input information (for example, a character string) by carrying out pattern-matching with the information in the bibliographic information list (for example, a character string). The pattern matching includes perfect matching, begins-with matching, ends-with matching, and partial matching. For example, when “CR” is input, the first controller 21 refers to the bibliographic information list, and extracts “CR” as the specific information. Thus, extraction of the input character string ends.

Similarly, the first controller 21 extracts the input information (for example, character string) by carrying out pattern-matching with the information in the bibliographic information list (for example, character string).

The first controller 21 refers to, for example, the correspondence relation between the combinations of specific information stored in the first storage 11 and the form type, and determines the form type based on the combination of the extracted specific information. For example, when “CR,” “chest region,” “cardiomegaly,” “hospital requesting an examination,” cardiothoracic ratio “◯,” and tone change “◯” are stored as specific information, the first controller 21 refers to the above-described correspondence relation and determines “form 1” as the form type.

### (S103)

The first controller 21 stores the combination of the extracted specific information and the determined form type in the first storage 11.

Thus, an example of the combination of specific information stored in the first storage 11 and a form type is indicated in the top part of FIG. 3.

Next, the operation when the specific information combined in common is extracted will be described with reference to FIG. 6. FIG. 6 is a flow chart depicting when specific information combined in common is extracted.

### (S201)

As illustrated in FIG. 6, the extraction unit 13 reads the form type stored in the first storage 11 in series.

### (S202)

Next, the extraction unit 13 inputs (reads) the specific information (for example, “CR”) with respect to the read form type (for example, “form 1”).

### (S203)

Next, the extraction unit 13 determines whether or not the read specific information is specific information common, for example, in “form 1.” The extraction unit 13 may determine that the specific information “CR” is specific information common in “form 1.” When the read specific information is determined as common specific information (step S203: Yes), the procedure shifts to step S204. On the other hand, the extraction unit 13 may determine that the specific information “hospital A” is not specific information common in “form 1.” When it is determined as uncommon specific information (step S203: No), the procedure shifts to step S205.

### (S204)

The second controller 22 stores the specific information “CR” in the second storage 12 as common specific information.

### (S205)

The extraction unit 13 determines whether or not other specific information exists. If other specific information exists (step S205; Yes), the procedure returns to input of specific information (step S202). If no other specific information exists (step S205; No), the procedure shifts to step S206.

### (S206)

The extraction unit 13 determines whether or not form types are left. If form types are left, the procedure returns to (step S201). If no form type is left, the procedure ends.

Thus, an example of the common combination of specific information stored in the second storage 12 and the form type is indicated in the bottom part of FIG. 3.

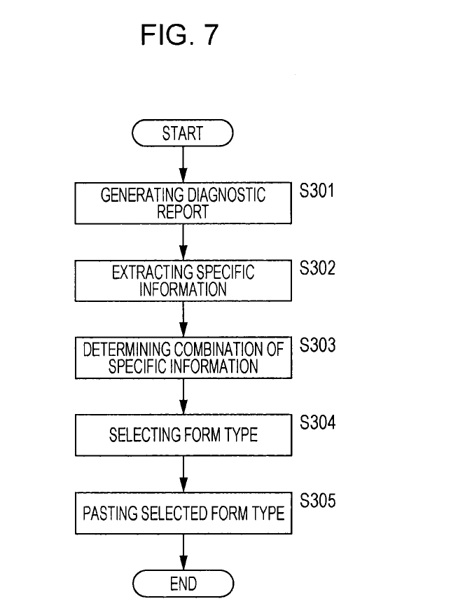

Next, a sequence of operations of the form automatic creating function will be described with reference to FIG. 4 and FIG. 7. FIG. 7 is a flow chart depicting when a form is used upon generation of a diagnostic report.

### (S301)

As illustrated in FIG. 7, upon generation of a diagnostic report, the selection unit 14 temporarily stores the information including the bibliographic information and the image operation information, for example, in an inner memory.

### (S302)

Next, the selection unit 14 extracts the specific information from the information temporarily stored in the inner memory, for example, with reference to the bibliographic information list and image operation information list stored in the first storage 11.

### (S303)

Next, the selection unit 14 determines a combination of specific information based on the extracted specific information, and stores these pieces of information temporarily in the inner memory. An example of a combination of temporarily stored specific information (“CR,” “chest region,” “cardiomegaly,” “,” “,” cardiothoracic ratio “◯,” tone change “◯”) is indicated in the top part of FIG. 4.

### (S304)

Next, the selection unit 14 selects a form type based on the combination of the determined specific information with reference to the correspondence relation between the combination of the specific information stored in the first storage 11 and the form type. An example of a common combination between the selected form type “form 1” and the specific information thereof (“CR,” “chest region,” “cardiomegaly,” “,” “,” cardiothoracic ratio “◯”) is indicated in the bottom part of FIG. 4.

### (S305)

The form creation unit 15 pastes the selected form type to the findings section.

Due to the above-described sequence of operations, a form type candidate is automatically extracted. As a result, the time required for selecting a form can be shortened, making it possible to shorten the time required for generating a report.

Further, the first controller 21 stores the combination of the specific information in the first storage 11 related to the form type pasted to the findings section.

### Second Embodiment

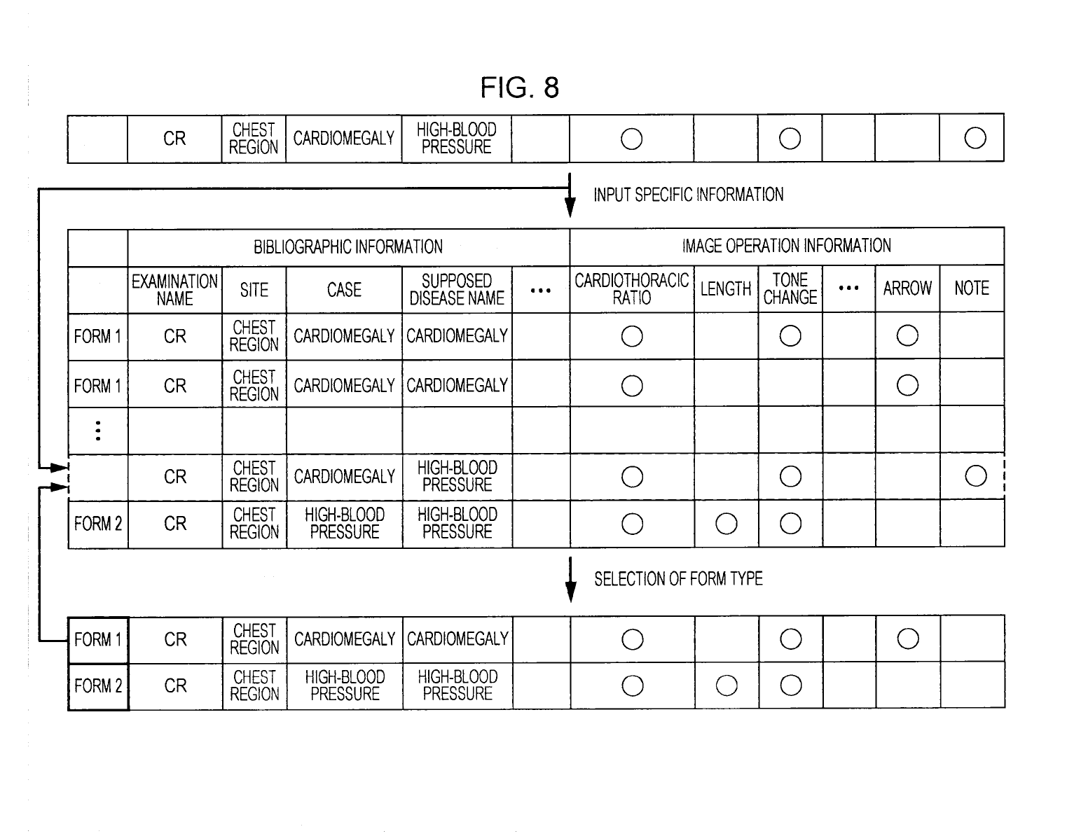

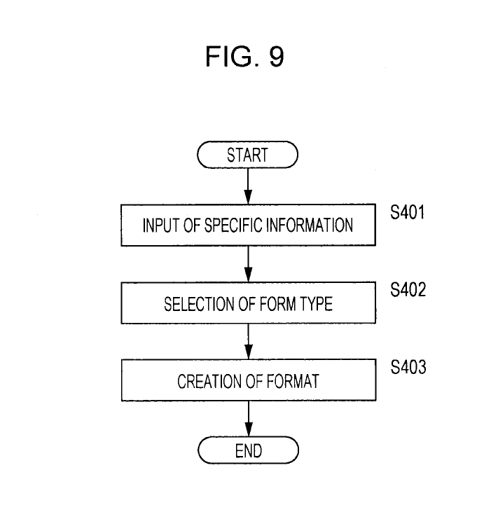

Next, the second embodiment of this diagnostic report generation support apparatus will be described with reference to FIG. 8 and FIG. 9. FIG. 8 is a conceptual illustration of the input specific information and the form type extracted based on the information, while FIG. 9 is a flow chart depicting when a form is used upon the generation of a report.

The configurations of the second embodiment different from the first embodiment will be mainly described, with descriptions of the same configurations herein omitted.

In the first embodiment, the common combination of specific information is stored in advance in the second storage 12 for each form type. It is indicated that the selection unit 14 selects one form type based on the common combination of the specific information stored in advance upon receiving the combination of specific information input when a report is subsequently generated.

On the contrary, the combination of specific information is merely stored in the first storage 11 related to the form type. Upon receiving the combination of specific information input when a report is subsequently generated, one or more form types may be selected based on the combination of specific information stored in the selection unit 14.

The top part of FIG. 8 indicates the input specific information. In addition, the middle part of FIG. 8 indicates the combination of the specific information stored in the first storage 11.

The middle part of FIG. 8 indicates the specific information (bibliographic information/image operation information) referred to when a form was used in the past. In the example indicated in the middle part of FIG. 8, the specific information stored related to “form 1” and the specific information stored related to “form 2” are indicated. Further, the illustration of the specific information stored related to other form types (“form 3,” . . . “form m”) is omitted.

In addition, the middle part of FIG. 8 indicates the specific information stored related to the form type as a data structure of an array type. The first row indicates the bibliographic information/image operation information as the type of specific information. The second column to the kth column of the second row indicate respective items such as “examination name,” “site,” “case,” “supposed disease name,” . . . , and further, the kth+1st column to the nth column of the second row indicate respective items such as “a cardiothoracic ratio,” “length,” “tone change,” . . . , “arrow,” “note.”

Further, the bottom part of FIG. 8 indicates the extracted form type.

### (Input of Specific Information: S401 of FIG. 9)

Upon generation of a report, the specific information is input into the selection unit 14.

### (Selection of Form Type: S402 of FIG. 9)

Upon receiving the input specific information, the selection unit 14 selects one or more form types satisfying a given condition based on the combination of the specific information stored in advance in the first storage 11.

An example of the given condition is represented by the following formula.

Q/P≧R (1)

Wherein, P is the number of the input specific information, Q is the number in which the input specific information matches to the stored specific information, and R is an acceptable value (for example, 0.7).

In the example indicated in the top part of FIG. 8, the combination of the specific information is “CR,” “chest region,” “cardiomegaly,” “high-blood pressure” . . . , “◯,” “,” “◯,” . . . , “◯.” In this example, P=7 is established.

The selection unit 14 carries out pattern matching between the input specific information and the specific information stored in advance in the first storage 11.

In the example indicated in the middle part of FIG. 8, the third row thereof indicates the form type “form 1” along with the specific information (“CR,” “chest region,” “cardiomegaly,” “cardiomegaly,” . . . , “◯,” “,” “◯,” . . . , “◯,” . . . ) stored in relation to this. In this example, Q=5 is established. Further, Q/P=0.71 is established, and the acceptable value becomes a value of (0.7) or more. Since this satisfies the condition, the selection unit 14 selects “form 1.”

In addition, the fourth row in the middle part indicates the form type “form 1” along with the specific information (“CR,” “chest region,” “cardiomegaly,” “cardiomegaly,” . . . , “◯,” “,” “ ” . . . , “◯,” “ ”) stored in relation to this. In this example, Q=4 is established. Further, Q/P=0.57 is established, and the acceptable value becomes a value of (0.7) or less. Since this does not satisfy the condition, the selection unit 14 does not select “form 1.”

Further, the jth row of the middle part indicates the form type “form 2” along with the specific information (“CR,” “chest region,” “high-blood pressure,” “high-blood pressure,” . . . , “◯,” “◯,” “◯” . . . , “,” “ ”) stored in relation to this. In this example, Q=5 is established. Further, Q/P=0.71 is established, and the acceptable value becomes a value of (0.7) or more. Since this satisfies the condition, the selection unit 14 selects “form 2.”

The bottom part of FIG. 8 indicates the specific information stored related to “form 1” selected by the selection unit 14, and the specific information stored related to “form 2.”

### (Creation of Format: S403 of FIG. 9)

The radiologist designates a form type (“form 1” or “form 2”). The form creation unit 15 receives the designation of a form type and pastes the designated form type to the diagnostic report.

Further, the first controller 21 stores the specific information input related to the designated form type in the first storage 11. The (j−1)th row in the middle part of FIG. 8 indicates the specific information related to a form type (“form 1”) and stored in the first storage 11.

### Modified Example

Next, a modified example of this diagnostic report generation support apparatus will be described with reference to FIG. 8.

In the second embodiment, a condition of whether or not the ratio between P (the amount of input specific information) and Q (the amount at which the input specific information matches the stored specific information) is within the acceptable range R (Q/P≧R) is indicated as a condition to be satisfied when the selection unit 14 selects one or more form types.

In the modified example, the given conditions are represented by the following formula.

T/S≧U (2)

Wherein, S is a comprehensive evaluation value weighting the input specific information, T is a comprehensive evaluation value weighting the stored specific information, and U is an acceptable value (for example, 0.7).

Regarding an example of weighting, the values of “5,” “5,” “5,” “3,” . . . , “5,” “5,” “5,” . . . “3,” “3” are allocated to the specific information (“examination name,” “site,” “case,” . . . “supposed disease name,” “a cardiothoracic ratio,” “length,” “tone change,” . . . , “arrow,” “note”) as weighting.

If the input specific information matches the specific information, the weighting thereof is provided. For example, when the input examination name “CR” matches the examination name “CR,” the weighting thereof “5” is provided. When they do not match, this weighting “5” is not provided (it becomes “◯”).

The values of “5,” “5,” “5,” “3,” “5,” “5,” “3” are weighted to the input specific information (“CR,” “chest region,” “cardiomegaly,” “high-blood pressure,” “,” “◯,” “,” “◯,” . . . , “,” “◯”) indicated in the top part of FIG. 8. The comprehensive evaluation value S derived by tallying these values becomes S=31.

In contrast, the values of “5,” “5,” “5,” “◯,” “5,” “5,” “◯” are weighted to the stored specific information (“CR,” “chest region,” “cardiomegaly,” “cardiomegaly,” “,” “◯,” “,” “◯,” . . . , “◯,” “ ”) of which an example is indicated on the third row in the middle part of FIG. 8, and tallying these values, the comprehensive evaluation value T becomes T=25. Further, T/S=0.80 is established, the acceptable value U becoming 0.7 or more. Since this satisfies the condition, the selection unit 14 selects “form 1.”

Further, the values of “5,” “5,” “5,” “◯,” “5,” “◯,” “◯” are weighted to the stored specific information (“CR,” “chest region,” “cardiomegaly,” “cardiomegaly,” “,” “0,” “,” . . . , “◯,” “ ”) of which an example is indicated on the fourth row in the middle part of FIG. 8, and tallying these values, the comprehensive evaluation value T becomes T=20. Further, when T/S=0.64 is established, the acceptable value U becomes less than 0.7. Since this does not satisfy the condition, the selection unit 14 does not select “form 1.”

Further, the values of “5,” “5,” “◯,” “3,” “5,” “◯,” “5” are weighted to the stored specific information (“CR,” “chest region,” “high-blood pressure,” “high-blood pressure,” “,” “◯,” “◯,” “◯,” . . . , “,” “ ”) of which an example is indicated on the jth row in the middle part of FIG. 8, and tallying these values, the comprehensive evaluation value T becomes T=23. Further, when T/S=0.74 is established, the acceptable value U becomes 0.7 or more. Since this satisfies the condition, the selection unit 14 selects “form 2.”

In the bottom part of FIG. 8, the specific information selected by the selection unit 14 and stored related to “form 1,” and the specific information stored related to “form 2” are indicated.

In the modified example described above, when the specific information matches each other, the given weighting is provided; however, predetermining a list regarding the similarity of the specific information, when the specific information is similar to each other, the weighting according to this may be provided.

### Third Embodiment

In the above-described respective embodiments, the selection unit 14 selected the form type from specific information including the bibliographic information and the image operation information (FIG. 7, step S304); however, in the present embodiment, the selection unit 14 determines disturbances occurring in the patient by comparison of the combination of specific information. After determining the disturbances, the selection unit 14 selects a form corresponding to the determined disturbances similar to the above-described respective embodiments. Further, the selection unit 14 may carry out different processing in accordance with the determined disturbances in place of selection of the form.

The summary of the bibliographic information and the image operation information was described with reference to FIGS. 2-4; however, in the present embodiment, it will be described with a different example. The image operation information includes the operation to a window on which images are displayed, namely, the operation with respect to a window level and a window width. The bibliographic information and the image operation information may be described in the present embodiment taking the specific information in the first and second embodiments as an example.

Regarding the flow of processing, the procedures until generation of a diagnostic report (step S301), extraction of the specific information (step S302), and determination of the combination of the specific information (step S303) are similar to the case illustrated in FIG. 7; however, the selection unit 14 determines the disturbances after comparing the combination of specific information. The disturbance is, for example, a cerebral vascular disturbance, with examples of the cerebral vascular disturbance including a brain hemorrhage, a subarachnoid hemorrhage, and brain infarction. The selection unit 14 selects a form corresponding to the disturbance after determining these disturbances. Carrying out the processing so far in place of step S304 in FIG. 7, the processing of step S305 is carried out similar to the case illustrated in FIG. 7.

### (Other Examples of Specific Information)

The bibliographic information includes main complaint information, physiological information, an examination name, and a site. The main complaint information includes headaches, impaired consciousness, and hemiplegia. The physiological information includes high blood pressure. The examination name includes CT, MRI, CTA/DSA/MRA. The site includes the head. In this example, since there is no large difference in the bibliographic information among a brain hemorrhage, a subarachnoid hemorrhage, and a brain infarction, the selection unit 14 determines to which cerebral vascular disturbance the disturbance corresponds mainly based on the content of the image operation information. Alternatively, the selection unit 14 determines to which cerebral vascular disturbance the disturbance corresponds based on the bibliographic information, and then, may determine to which cerebral vascular disturbance the failure corresponds based on the image operation information. Moreover, this may be determined from the image operation information alone without consideration to the bibliographic information, and when taking into consideration multiple cases from the image operation information, it may be determined to which disturbance it corresponds with reference to the bibliographic information.

The image operation information includes to what extent WW (window width) and WL (window level) have been changed in a pre-contrast CT scan (CT-scan before administering contrast agent) in order to confirm traumatic injuries. In addition, the image operation information includes to what extent WW (window width) and WL (window level) have been changed in the pre-contrast CT scan in order to confirm bleeding. Further, the image operation information includes whether or not a FLAIR (Fluid-Attenuated Inversion Recovery) image or a T2* (T2 star) weighted image (T2*WI) appears upon MRI in order to confirm bleeding. In addition, the image operation information includes whether or not 3D images are created by WS in order to confirm aneurysm. Further, the image operation information includes whether or not a diffusion-weighted image or the FLAIR image appears in the MRI in order to confirm infarction. Moreover, regarding changes in the WW (window width) and WL (window level), not only whether or not one operation was carried out, but also whether or not multiple operations were carried out may be used as a determination factor. For example, the presence of multiple operations such as setting WL=30 and WW=200 and then subsequently setting WL=60 and WW=100 may be used as the determination factor.

In step S304, the selection unit 14 determines the type of the cerebral vascular disturbance based on the combination of the determined specific information with reference to the correspondence relation between the combination of the specific information stored in the first storage 11 and the type of cerebral vascular disturbance. The selection unit 14 is capable of determining the types of disturbance according to the evaluation results, or, it may be assumed that the evaluation results require other tests such as MRI scan, etc. in order to evaluate more precisely. In the event that the results require further tests, the content thereof may be determined. For example, if the head is diagnosed with acute phase hemorrhage upon CT scan, the presence of hemorrhage may be assessed, as mentioned later, under the assumption that a case is determined as not having a hemorrhage. If a hemorrhage is not observed, it is determined that the case be handled as an infarction, in addition to being required to undergo an MRI, and it may be assumed that the evaluation results confirm the final infarction and arteriosclerosis evaluation upon head MRI scanning when the apparent infraction is found upon CT scanning. In addition, if there is no apparent low-density area or if the area is localized upon CT scanning, it may be assumed that the evaluation results diagnose the case as acute phase cerebral ischemia upon head MRI scanning.

### (Window Width and Window Level)

In the present embodiment, CT numbers and medical images are obtained by photographing test objects using a CT scanner. An 8 bit of 2 to the power of 8=256 gradations are used regarding the concentration scale of the CT scan and medical images are expressed with the gradations. Meanwhile, CT numbers define the X-ray absorption rate of water as OHU and the X-ray absorption rate of air as −1000, showing the relative value of the X-ray absorption degree of each substance with respect to these. The concentration scale of the CT scan is expressed in association with the CT number; however, important areas are not necessarily clearly displayed even if the entire range of the CT number is fully associated with the entire range of the gradation. Accordingly, an operation is carried out to obtain the desired display results by means of defying the correspondence with the WW (window width) and WL (window level), and associating the entire range or part of the range of the gradation with the necessary range of the CT number. The image operation information comprises the changing process of the correspondence between the medical image gradations and the CT number.

Here, the window level is the CT number to be the principle, with the window width referring to the range displaying the gradation. For example, if the window level is 35 and the window width is 100, the principle CT number becomes 35, while the width of 100 associated with this as the principle becomes the subject for observation. That is, CT numbers of −15 to 85 become the subject for observation, and gradations of 0-255 are associated with the range. In addition, the range may be narrowed and associated with the gradation from the range of 40-220. Conversely, when the CT number exceeds the range (for example, if the CT number is 100), the gradation becomes 255; therefore, the range will be displayed as a whitish color. When the range of selection of the WW (window width) and WL (window level) is, for example, a WW of 100 and a WL of 35, it may be determined that the image operation thereof was carried out when the value is reached; however, even when the setting operation was carried out within a certain degree of the range, such as when, for example, the WW is set to any from among the range within 90-110 and WL is set to any from among the range within 30-40, it may be determined that the corresponding image operation has been carried out.

### (Detailed Example of Cerebrovascular Disease)

Cases of cerebral hemorrhage, subarachnoid hemorrhage, and cerebral infarction are explained as specific examples of cerebrovascular disease.

Regarding a brain hemorrhage that is one type of cerebral vascular disturbance, as bibliographic information, the main complaint information includes headaches, impaired consciousness, and hemiplegia, the physiological information includes high blood pressure, the examination name includes CT, MRI, and the site includes the head. When the selection unit 14 determines that the combination of identified bibliographic information includes these, the bibliographic information corresponds to a brain hemorrhage.

In the case of cerebral hemorrhage, regarding the image operation information, whether or not WW (window width) in the pre-contrast CT scan is changed to 300 and whether or not WL (window level) is changed to 35 is included in order to confirm traumatic injuries and bleeding. In this case, the selection unit 14 determines that the image operation information also corresponds to a brain hemorrhage. When both the bibliographic information and the image operation information correspond to a brain hemorrhage, the selection unit 14 determines that the type of the cerebral vascular disturbance is a brain hemorrhage.

Regarding a subarachnoid hemorrhage, as the bibliographic information, the main complaint information includes headaches, impaired consciousness, and hemiplegia, the physiological information includes high blood pressure, the examination name includes CT, MRI, CTA/DSA/MRA, and the site includes the head. When the selection unit 14 determines that the combination of bibliographic information includes these, the bibliographic information corresponds to a subarachnoid hemorrhage.

In the case of subarachnoid hemorrhage, regarding the image operation information, whether or not WW (window width) in the pre-contrast CT scan is changed to 300, and whether or not WL (window level) is changed to 35 is included in order to confirm traumatic injuries. In addition, it is included that whether or not the FLAIR (FLuid-Attenuated Inversion Recovery) image or the T2* (T2 star) weighted image (T2*WI) appears upon MRI. Further, whether or not 3D images are created by WS is included in order to confirm an aneurysm. When the image operation information corresponds to these, the selection unit 14 determines that the image operation information also corresponds to the subarachnoid hemorrhage. When both the bibliographic information and the image operation information correspond to a subarachnoid hemorrhage, the selection unit 14 determines that the type of the cerebral vascular disturbance is a subarachnoid hemorrhage.

Regarding a brain infarction, as the bibliographic information, the main complaint information includes headaches, impaired consciousness, and hemiplegia, the physiological information includes high blood pressure, the examination name includes CT, MRI, and the site includes the head. When the selection unit 14 determines that the combination of the identified bibliographic information includes these, the bibliographic information corresponds to a brain infarction.

In the case of cerebral infarction, regarding the image operation information, whether or not WW (window width) in the pre-contrast CT scan is changed to 10, and whether or not WL (window level) is changed to 35 is included in order to confirm bleeding. In addition, whether or not the diffusion-weighted image or the FLAIR image appears in the MRI is included in order to confirm infarction. When the image operation information corresponds to these, the selection unit 14 determines that the image operation information also corresponds to a brain infarction. When both the bibliographic information and the image operation information correspond to a brain infarction, the selection unit 14 determines that the type of cerebral vascular disturbance is a brain infarction.

When the selection unit 14 determines that the type of cerebral vascular disturbance corresponds to any of a brain hemorrhage, a subarachnoid hemorrhage, and a brain infarction, the selection unit 14 selects a form type corresponding to these cerebral vascular disturbances.

### (Setting the Window Width and Window Level)

As mentioned above, the specifying information comprises the image operation information, while the image operation information comprises the setting operation of WW (window width) and WL (window level), so the setting operation is described. The setting operation includes changing using a mouse or keyboard, changing by inputting the CT number, and changing by preset registration.

When changing using a mouse or keyboard, the gradation change is selected by vertically and horizontally operating on the selected screen. Specifically, the window level is associated with the vertical operation, increasing the window level for up and decreasing the window level for down. The window width is associated with the horizontal operation, decreasing the window width for left and increasing the window width for right. Regarding a mouse, the vertical and horizontal range is specified by the operation of dragging to the left, and regarding keyboards, the vertical and horizontal range is specified by pressing the arrow key while pressing the Ctrl key.

In addition, an input part for window width and window level may be provided in the tool bar, and the window width and window level may be input here. Moreover, the window width and window level may be registered as a preset value for each item, allowing the selection of the window width and window level by selecting the preset value.

By means of the operation, the window width and window level may be selected and the medical images may be displayed allowing for appropriate confirmation, with the disturbance of the subjects able to be determined from such confirmation operations and appropriate fixed phase capable of being selected upon making an interpretation report. That is, a difficult interpretation report may be simplified by means of easy operation.

While certain embodiments have been described, these embodiments have been presented by way of example only, and are not intended to limit the scope of the inventions. Indeed, the novel systems described herein may be embodied in a variety of their forms; furthermore, various omissions, substitutions and changes in the form of the systems described herein may be made without departing from the spirit of the inventions. The accompanying claims and their equivalents are intended to cover such forms or modifications as would fall within the scope and spirit of the inventions.

### EXPLANATION OF THE SYMBOLS

1 diagnostic report generation support apparatus
2 medical image archive apparatus
3 medical image referring apparatus
4 report server
5 client terminal
6 web server
7 HIS; Hospital Information System
8 RIS; Radiology Information System
9 medical imaging apparatus (modality)
11 first storage,
12 second storage,
13 extraction unit
14 selection unit,
15 form creation unit,
21 first controller,
22 second controller

What is claimed is:

1. A diagnostic report generation support apparatus for supporting the generation of a report using a form, comprising:
a first controller configured to store one or more pieces of the specific information in a first storage in advance to be associated with variation of form types used in the past, the specific information being referred to when using the form type;
an extraction unit configured to extract, for each of the form types, a piece of specific information that is commonly referred to among respective forms from among the specific information stored in the first storage in advance to generate a common combination of the specific information; and
a second controller configured to store the common combination of the specific information in a second storage in advance for each of the form types.

2. The diagnostic report generation support apparatus according to claim 1, further comprising:
a selection unit configured to select one or more form types based on the common combination of the specific information stored in the second storage in advance, in response to entry of a combination of the specific information; and
a form creation unit configured to paste the selected form types to the diagnostic report.

3. The diagnostic report generation support apparatus according to claim 1, wherein the extraction is carried out by pattern matching including perfect matching, begins-with matching, ends-with matching, and partial matching.

4. The diagnostic report generation support apparatus according to claim 1, wherein the specific information has bibliographic information including at least the type of examination, and/or medical image operation information obtained in a process of operations for imaging the test object, the medical image operation information including at least the tone change to the medical images.

5. The diagnostic report generation support apparatus according to claim 4, wherein the bibliographic information comprises examination names, examination sites, clinical disease names, medical histories, drugs, a hospital that introduces a patient, or request fees, or a combination of two or more of these, and
the image operation information comprises tone change, image processing, or measurement marking or a combination of two or more of these.

6. The diagnostic report generation support apparatus according to claim 4, wherein the image operation information comprises a changing operation to the correspondence of gradation of the medical images with a CT number obtained by imaging the test image.

7. The diagnostic report generation support apparatus according to claim 4, further comprising:
an input unit configured to enter the specific information, and
a display unit configured to display the medical images, wherein
the display unit is configured to change the gradation of the medical images which is displayed based on the image operation information included in the specific information entered by the input unit.

8. The diagnostic report generation support apparatus according to claim 2, wherein
the selection unit is configured to select the disturbance generated in the test object based on the common combination of the specific information stored in the second storage.

9. A diagnostic report generation support apparatus for supporting the generation of a report using a form, comprising:
a first controller configured to store one or more pieces of the specific information in a first storage in advance to be associated with variation of form types used in the past, the specific information being referred to when using the form;
a selection unit configured to select one or more form types based on the common combination of the specific information stored in the first storage, in response to entry of a combination of the input specific information; and
a form creation unit configured to paste the selected form type to the diagnostic report in response to the designation of the type.
